(19) United States
(12) Patent Application Publication
(10) Pub. No.: US 2025/0238473 A1
(43) Pub. Date: Jul. 24, 2025

(54) METHOD FOR PROVIDING A CONTENT INCLUDING A PLURALITY OF DIGITAL CUTS AND ELECTRONIC DEVICE FOR THE SAME

(71) Applicant: Glitter Company, San Jose, CA (US)

(72) Inventor: Sungpa PARK, Fremont, CA (US)

(21) Appl. No.: 18/612,592

(22) Filed: Mar. 21, 2024

Related U.S. Application Data
(63) Continuation of application No. 18/421,322, filed on Jan. 24, 2024, now abandoned.

(51) Int. Cl. G06F 16/9538; G06F 16/957

(52) U.S. Cl. CPC G06F 16/9538; G06F 16/9577

(57) ABSTRACT

A method of providing a content including a plurality of digital cuts, the method performed by an electronic device and including identifying first information of components included in each digital cut included in the plurality of digital cuts based on a creator input. The method further comprises generating a first file in a first format based on the first information, changing the first file in the first format into a second file in a second format, and providing the content through a user terminal based on the second file in the second format.

### RELATED APPLICATION

This application is a continuation of U.S. patent application Ser. No. 18/421,322 filed on Jan. 24, 2024, which is incorporated herein by reference in its entirety.

### BACKGROUND

### Technical Field

The present disclosure relates to a technology of providing a content including a plurality of digital cuts.

### Description of Related Art

A platform for providing a content, such as web comics or a web novel, has been developed lately in various ways. The platform for providing the content has allowed a content creator to decrease dependence on an existing publisher by providing a space in which the content creator may create and directly publish the content to communicate with a content consumer. In addition, unlike conventional content providing methods in which the existing publisher has provided an unalterable content to a content consumer in a one-way manner, certain content providing platforms are developing functions to use a content in various aspects and fields through interactions between the content creator and multiple content consumers. Through these function, a content is generated, and there is a growing need to further efficiently manage the content.

### SUMMARY

An aspect of the present disclosure provides a method of providing a content including a plurality of digital cuts and an electronic device therefor.

Specifically, an embodiment of the present disclosure identifies first information of components included in each digital cut included in the plurality of digital cuts based on a creator input, generates a first file in a first format based on the first information, changes the first file in the first format into a second file in a second format, and provides the content through a user terminal based on the second file in the second format.

Certain embodiments of the present disclosure relate to a method of providing the content including the plurality of digital cuts and the electronic device therefor. However, the goals to be achieved by embodiments of the present disclosure are not limited to the objectives described above and other objectives may be further inferred from other parts of the specification, including the following embodiments.

According to an aspect, the specification provides a method of providing a content including a plurality of digital cuts. The method can be performed by an electronic device and include identifying first information of components included in each digital cut included in the plurality of digital cuts based on a creator input, generating a first file in a first format based on the first information, changing the first file in the first format into a second file in a second format, and providing the content through a user terminal based on the second file in the second format.

The method may include providing the content in a web page based on the second file in the second format, and the first information may be searchable through the web page.

The method may include generating the first file in the first format in consideration of a size of each digital cut included in the plurality of digital cuts, a ratio of a size of a component included in each digital cut to the size of each digital cut, and a position of the components included in each digital cut.

The method may include identifying the first information of at least one component selected from a text, a text box surrounding the text, an image, a sound, and a video.

A size of the text may be changed in proportion to a size of a digital cut.

A size of the text box may be changed in proportion to a length of the text.

The text may be character-recognizable.

The first information may include information of a predetermined first action corresponding to a first event. The first event may be associated with a first component among the components included in each cut. The method may further include providing the first action through the user terminal when the first event occurs.

The method may further include storing a plurality of components associated with an advertisement in a database, identifying a first component included in the plurality of components in the content, and calculating a reward for a content creator of the content in consideration of at least one of a view count of the content and an influence score of the first component in a digital cut.

The influence score of the first component may be calculated in consideration of size information and/or position information of the first component in the digital cut.

The method may further include receiving, through the user terminal, user input information associated with a first component included in the components included in each digital cut, and providing the content that includes the user input information added through another user terminal.

The method may further include receiving information about an accuracy of the content from a plurality of user terminals, calculating an accuracy score of the content based on the received information, and providing information of the accuracy score of the content to the user terminal. The number of times of a user input on the information of the accuracy of the content may be within a range predefined for each of the user terminals.

The method may further include providing a list of a plurality of pieces of contents arranged based on an accuracy score of each of the plurality of pieces of contents.

The method may further include identifying second information of an order of exposure for a first digital cut and a second digital cut based on the creator input. The method may include generating the first file in the first format based on the first information and the second information, and providing, when the user terminal receives an input for selecting the first digital cut from at least a portion of the digital cuts, the content which displays the first digital cut followed by the second digital cut to the user terminal.

The method may further include storing information on a plurality of components in a database based on at least one creator input, identifying at least one of the components included in each cut and identification information of a creator based on the creator input.

Identification information of a first component included in the plurality of components may include identification information of a first creator generating the first component, and the method may further include calculating a reward for the first creator in consideration of a number of times of using the first component in a plurality of pieces of contents.

The method may further include determining whether the user terminal satisfies a predetermined condition, and providing the content which excludes at least one digital cut or at least one component to the user terminal when the user terminal does not satisfy the predetermined condition. The predetermined condition may include at least one of a condition of a membership subscription to a platform associated with the content and/or a condition of payment associated with the content.

The method, when the user terminal does not satisfy the predetermined condition, may further include providing details for the condition of a membership subscription to the platform and/or the condition of the payment.

The first file in the first format may be a Javascript Object Notation (JSON) file, and the second file in the second format may be a Hypertext Markup Language (HTML) file.

According to another aspect, the present disclosure provides an electronic device for performing a method of providing a content including a plurality of digital cuts, the electronic device including a communication part configured to communicate with a user terminal, and a controller configured to implement the method. The method includes identifying first information on components included in each digital cut included in the plurality of digital cuts based on a creator input, generating a first file in a first format based on the first information, changing the first file in the first format into a second file in a second format, and providing the content through a user terminal based on the second file in the second format.

Additional aspects of the present disclosure will be set forth in the description which follows and, in part, will be apparent from the description, or may be learned by practice of the disclosure.

According to certain embodiments, it is conceived to provide, to a user terminal through an electronic device, a content including a plurality of digital cuts generated based on an input to a creator terminal. In addition, the content is provided to the user terminal based on a file in a second format different from a first format after a file in the first format for the content is generated. Through this method, unlike providing content based on an existing unalterable image, it is conceived to provide the content which has a flexible component that is changeable via information of each component included in the content being maintained. Accordingly, a user consuming the content including the plurality of digital cuts may consume content differently prepared by a content creator. Also, a content consumer may interact with the content creator or other different users by directly changing components of the content. Furthermore, with respect to a content for conveying knowledge required to secure objectivity, an opportunity to receive the content with a higher reliability may be provided through a function for determining accuracy with which the user determines details of the content to be correct or incorrect.

A content creator creating the content including the plurality of digital cuts may prepare an advertisement for an item desired by an advertiser and distribute the advertisement through a platform associated with the electronic device including the plurality of digital cuts without directly signing an advertisement contract with the advertiser. As a result, the creator may acquire a reward accordingly.

Additionally, the content creator providing the content including the plurality of digital cuts according to the present disclosure may use various components created in advance by other content creators and consumers using the platform. Through this method, the content creator may forward a created content to multiple content consumers regardless of an existing high entry barrier.

Effects of the present disclosure are not limited to those described above and other effects may be made apparent to those skilled in the art from the following description.

### BRIEF DESCRIPTION OF THE DRAWINGS

These and/or other aspects, features, and advantages of the invention will become apparent and more readily appreciated from the following description of various embodiments, taken in conjunction with the accompanying drawings of which:

FIG. 1 is a schematic diagram illustrating a system for providing a content including a plurality of digital cuts according to an embodiment

FIG. 2 is a block diagram illustrating an electronic device, a creator terminal, and a user terminal according to an embodiment;

FIG. 3 is a diagram illustrating content provided to a user terminal according to an embodiment;

FIGS. 4A and 4B are diagrams illustrating an example of a text included in a digital cut according to an embodiment;

FIG. 5 is a diagram illustrating an example of each component included in a plurality of digital cuts according to an embodiment.

FIGS. 6A and 6B are diagrams illustrating an advertisement function using a content including a plurality of digital cuts according to an embodiment;

FIGS. 7A and 7B are diagrams illustrating an example of an interaction based on a content including a plurality of digital cuts according to an embodiment;

FIGS. 8A and 8B are diagrams illustrating an embodiment of providing different contents including a plurality of digital cuts according to an embodiment;

FIG. 9 is a diagram illustrating an embodiment of providing a content including a plurality of digital cuts to a user terminal depending on whether a predetermined condition is satisfied according to an embodiment;

FIG. 10 is a flowchart illustrating a method of providing a content including a plurality of digital cuts according to an embodiment; and

FIG. 11 is a block diagram illustrating an electronic apparatus, a creator terminal, and a user terminal according to an embodiment.

### DETAILED DESCRIPTION

Terms used in the embodiments of the present disclosure are selected, as much as possible, from general terms that are widely used at present while taking into consideration the functions obtained in accordance with the present disclosure, but these terms may be replaced by other terms based on intentions of those skilled in the art, customs, emergence of new technologies, or the like. In certain cases, terms may have been arbitrarily named by the applicant of the present disclosure. In these cases, the meanings of these terms may be described in corresponding description parts of the disclosure. Accordingly, it should be noted that the terms used herein should be construed based on practical meanings thereof and the whole content of this specification, rather than being simply construed based on names of the terms.

In the entire specification, when an element is referred to as “including” another element, the element should not be understood as excluding other elements so long as there is no special conflicting description, and the element may include at least one other element. In addition, the terms “unit” and “module”, for example, may refer to a component that exerts at least one function or operation, and may be realized in hardware or software, or may be realized by combination of hardware and software.

Throughout the specification, expression “at least one of a, b, and c” may include ‘a only’, ‘b only’, ‘c only’, ‘a and b’, ‘a and c’, ‘b and c’, or ‘all of a, b, and c’.

In the present disclosure, a “terminal” may be implemented as a computer or a portable terminal capable of accessing a server or another terminal through a network. Here, the computer may include, for example, a laptop computer, a desktop computer, and a notebook equipped with a web browser. The portable terminal may be a wireless communication device ensuring a portability and a mobility, and include any type of handheld wireless communication device, for example, a tablet PC, a smartphone, a communication-based terminal such as international mobile telecommunication (IMT), code division multiple access (CDMA), W-code division multiple access (W-CDMA), and long term evolution (LTE).

In the following description, embodiments of the present disclosure will be described in detail with reference to the drawings so that those skilled in the art can easily carry out the present disclosure. The present disclosure may be embodied in many different forms and is not limited to the embodiments described herein.

Hereinafter, embodiments of the present disclosure will be described with reference to the drawings.

In describing the embodiments, descriptions of technical contents that are well known in the art to which the present disclosure belongs and are not directly related to the present specification may be omitted to more clearly communicate, without obscuring, the subject matter of the present specification.

For the same reason, in the accompanying drawings, some components are exaggerated, omitted or schematically illustrated. In addition, the size of each component does not fully reflect the actual size. The same or corresponding components in each drawing are given the same reference numerals, whenever possible.

Advantages and features of the present disclosure and methods of achieving them will be apparent from the following embodiments that will be described in more detail with reference to the accompanying drawings. It should be noted, however, that the present disclosure is not limited to the following embodiments, and may be implemented in various forms. Accordingly, the embodiments are provided only to disclose the present disclosure and let those skilled in the art know the category of the present disclosure. In the drawings, embodiments of the present disclosure are not limited to the specific examples provided herein and are exaggerated for clarity. The same reference numerals or the same reference designators denote the same elements throughout the specification, whenever possible.

Each block of the flowchart illustrations and combinations of flowchart illustrations may be performed by computer program instructions. Since these computer program instructions may be mounted on a processor of a general purpose computer, special purpose computer, or other programmable data processing equipment, those instructions executed through the computer or the processor of other programmable data processing equipment may perform the functions be described in flowchart block(s). These computer program instructions may be stored in a computer usable or computer readable memory that can be directed to a computer or other programmable data processing equipment to implement functionality in a particular manner. It is also possible for the instructions stored in the computer usable or readable memory to produce an article of manufacture containing instruction for performing the functions described in the flowchart block(s). Computer program instructions may also be mounted on a computer or other programmable data processing equipment, such that a series of operating steps may be performed on the computer or other programmable data processing equipment to create a computer-implemented process to create a computer or other programmable data. Instructions for performing the processing equipment may also provide steps for performing the functions described in the flowchart block(s).

In addition, each block may represent a portion of a module, segment, or code that includes one or more executable instructions for executing a specified logical function(s). It should also be noted that in some alternative implementations, the functions noted in the blocks may occur out of order. For example, the two blocks shown in succession may in fact be executed substantially concurrently, or the blocks may sometimes be executed in the reverse order, depending on the corresponding function.

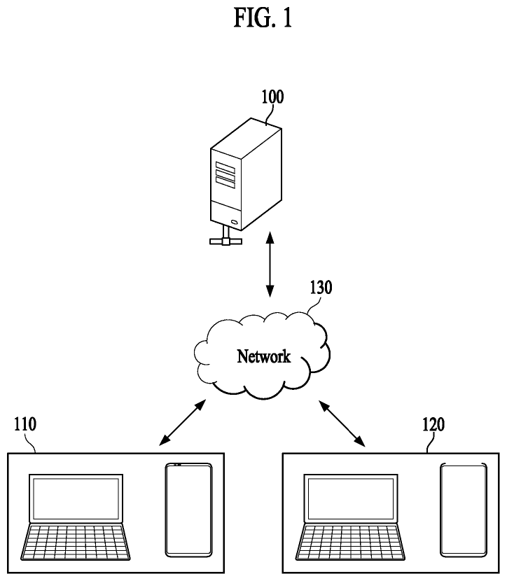

FIG. 1 is a conceptual diagram illustrating a system for providing a content including a plurality of digital cuts according to an embodiment.

Referring to FIG. 1, the system for providing the content including the plurality of digital cuts according to embodiments of the present disclosure may include an electronic device 100, a creator terminal 110 coupled with the electronic device 100, and a user terminal 120 coupled with the electronic device 100. Meanwhile, the system or a method of providing the content including the plurality of digital cuts according to embodiments of the present disclosure may include additional electronic devices or servers and may not be limited as illustrated in FIG. 1.

The electronic device 100 may perform wired or wireless communication with the user terminal 120 coupled with the electronic device 100 and may be a device including a storage having a large storage volume. For example, the electronic device 100 may be a cloud device connected to the user terminal 120. In other words, the method of providing the content including the plurality of digital cuts according to embodiments of the present disclosure may be implemented in a logical device of the cloud device.

The creator terminal 110 coupled with the electronic device 100 according to an embodiment may be a device such as a desktop computer, a tablet computer, or a mobile terminal to be used by a service user. In addition, other electronic devices performing a similar function may be used as the creator terminal 110 coupled with the electronic device 100.

The user terminal 120 coupled with the electronic device 100 according to an embodiment may be a device such as a desktop computer, a tablet computer, or a mobile terminal to be used by a service user. In addition, other electronic devices performing a similar function may be used as the user terminal 120 coupled with the electronic device 100.

The electronic device 100, the creator terminal 110, and the user terminal 120 may communicate with each other in a network 130. The network 130 may include a local area network (LAN), a wide area network (WAN), a value-added network (VAN), a mobile radio communication network, a satellite network, and a combination thereof. Also, the network 130 may be a data network in an inclusive sense of allowing each entity shown in FIG. 1 to properly communicate with each other. In addition, the network 160 may include the wired Internet, the wireless Internet, and a mobile wireless communication network. Examples of wireless communication may include a wireless-fidelity (Wi-Fi) LAN, Bluetooth, Bluetooth low energy, ZigBee, Wi-Fi Direct (WFD), ultra-wideband (UWB), infrared data association (IrDA), near field communication (NFC), or the like. However, it is merely an example.

Various modules for an operation according to embodiments of the present disclosure may be provided. The modules may include a computer code or one or more instructions implemented to perform an operation designated by a physical device (e.g., the electronic device 100) in which a content providing method is implemented or included. In other words, the physical device in which the content providing method is implemented may store a plurality of modules in a form of the computer code in a storage. When the plurality of modules stored in the storage are executed, the plurality of modules may allow the physical device to perform designated operations corresponding to the plurality of modules.

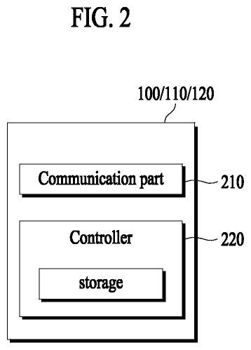

FIG. 2 is a block diagram illustrating an electronic device, a creator terminal, and a user terminal according to an embodiment.

Referring to FIG. 2, each of the electronic device 100, the creator terminal 110 coupled with the electronic device 100, and the user terminal 120 coupled with the electronic device 100 each may include a communication part 210 and a controller 220.

The communication part 210 may communicate with other devices. Thus, the electronic device 100, the creator terminal 110 coupled with the electronic device 100, and the user terminal 120 coupled with the electronic device 100 may transmit and receive information to and from the other devices through the communication part 210. For example, the electronic device 100, the creator terminal 110 coupled with the electronic device 100, and the user terminal 120 coupled with the electronic device 100 may use the communication part 210 to perform communication with each other or other additional devices. At this point, the communication, namely, transmission and reception of data, may be performed in wire or wirelessly. To this end, the communication part 210 may include a wired communication module for connecting to the Internet or the like through a local area network (LAN), a mobile communication module for transmitting and receiving data by connecting to a mobile communication network via a mobile communication base station, a near field communication module using a communication method of a type of a wireless local area network (WLAN) such as Wireless-Fidelity (Wi-Fi) or a communication method of a type of a wireless personal area network (WPAN) such as Bluethooth or Zigbee, a satellite communication module using a global navigation satellite system (GNSS) such as a global positioning system (GPS), or a combination thereof.

The controller 220 may control overall operations of the electronic device 100, the creator terminal 110 coupled with the electronic device 100, and the user terminal 120 coupled with the electronic device 100. To this end, the controller 220 may perform calculation and processing of a variety of information and control operations of components of the electronic device 100. For example, the controller 220 may execute a program or an application for providing a content including a plurality of digital cuts. The controller 220 may be implemented as a computer or a similar device depending on hardware, software, or a combination thereof. In terms of the hardware, the controller 220 may be implemented in a form of an electronic circuit processing an electric signal to perform a control function. In terms of the software, the controller 220 may be implemented in a form of a program driving the controller 220 as the hardware. In addition, the controller 220 may include a storage in which a variety of information may be stored. The storage may temporarily or semi-permanently store data. For example, the storage may store at least one instruction, and a storage of the electronic device 100 may store an operating system (OS) for driving the electronic device 100, data for hosting a website, data on a program or an application (e.g., a web application) for generating braille, or the like. An example of the storage may include a hard disk drive (HDD), a solid state drive (SSD), a flash memory, a read-only memory (ROM), a random access memory (RAM), or the like. The storage as such may be provided in a built-in type or a detachable type.

Meanwhile, unless additionally described in the following description, it may be construed that the operations of the electronic device 100, the creator terminal 110 coupled with the electronic device 100, and the user terminal 120 coupled with the electronic device 100 are performed under the control of the controller 220. In other words, when modules for a method according to an embodiment are executed, it may be construed that the modules allow the controller 220 to control the electronic device 100, the creator terminal 110 coupled with the electronic device 100, and the user terminal 120 coupled with the electronic device 100 to perform operations of a method of providing the content including the plurality of digital cuts.

In an embodiment, the controller 220 may control the electronic device 100 to identify first information of components included in each digital cut included in the plurality of digital cuts based on a creator input, generate a first file in a first format based on the first information, change the first file in the first format into a second file in a second format, and provide the content through the user terminal 120 based on the second file in the second format.

In summary, various embodiments may be implemented in various ways. For example, various embodiments may be implemented by hardware, firmware, software, or a combination thereof. When various embodiments are implemented by a hardware, a method according to an embodiment may be implemented by one or more of application specific integrated circuits (ASICs), digital signal processors (DSPs), digital signal processing devices (DSPDs), programmable logic devices (PLDs), field programmable gate arrays (FPGAs), a controller, a microcontroller, or the like. When various embodiments are implemented by a firmware or software, a method according to an embodiment may be implemented in a form of a module, a procedure, a function, or the like performing the functions or the operations described hereinafter. For example, a software code may be stored in a storage and operated by a controller. The storage may be inside or outside the controller. The storage may send and receive data to and from the controller through various methods known in advance. Hereinafter, embodiments will be described in detail based on the technical spirit described above. The above descriptions may be applied to embodiments in the following description. For example, an operation, a function, terms, or the like undefined in an embodiment in the following description may be performed and described based on the above descriptions. Hereinafter, an embodiment will be described under an assumption that the electronic device 100 performs the operations of the method of providing the content including the plurality of digital cuts. According to an embodiment, the electronic device 100 may transmit and receive information associated with the operations of the method of providing the content including the plurality of digital cuts to and from the creator terminal 110 and the user terminal 120 coupled with the electronic device 100.

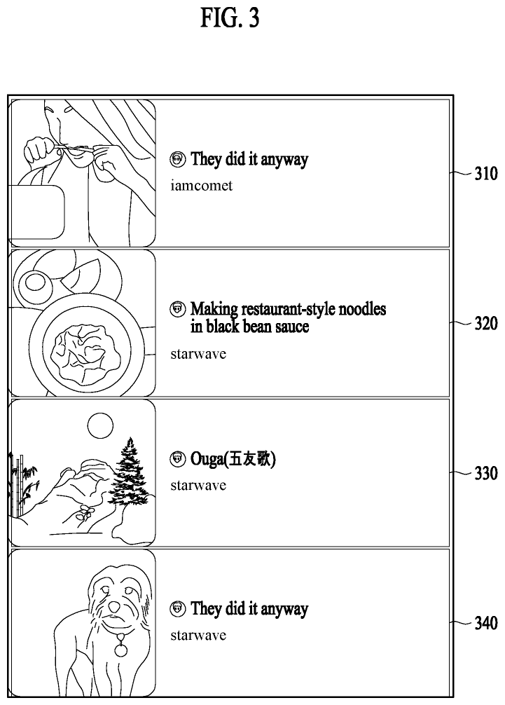

FIG. 3 is a diagram illustrating a content provided to a user terminal according to an embodiment.

The related method of providing a content, such as web comics, has mainly included a conventional method of changing various components, such as a text, a speech bubble, or an image into one unalterable image. Accordingly, a loss of data has occurred in a procedure of changing those components, such as an original text or an original image, into the one unalterable image. In addition, there has been a problem in which it is difficult for a content creator creating the content through the creator terminal 110 or content users consuming the content through the user terminal 120 to flexibly use the content.

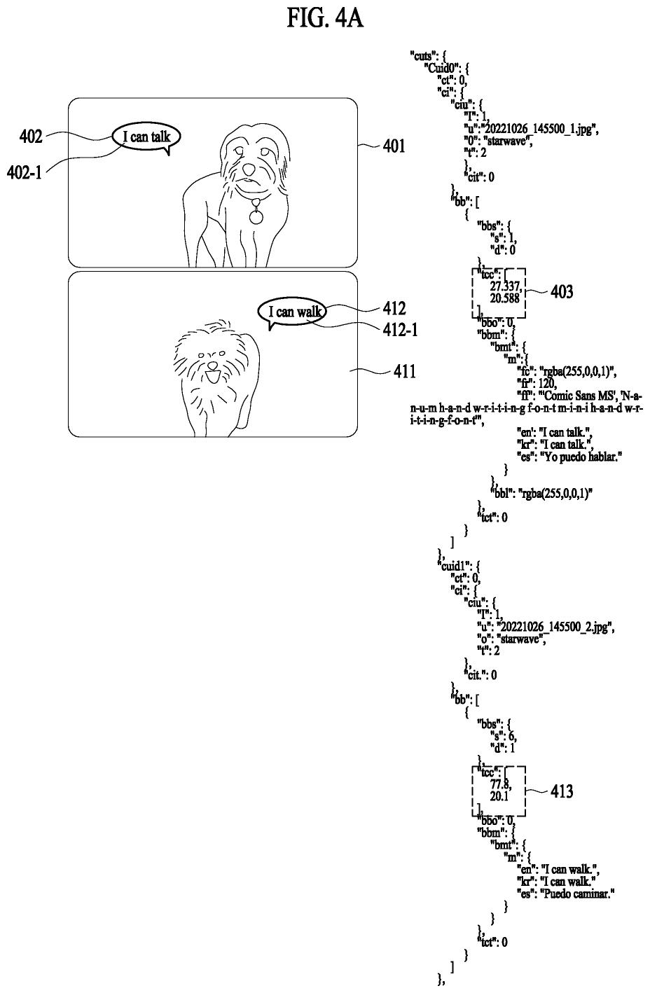

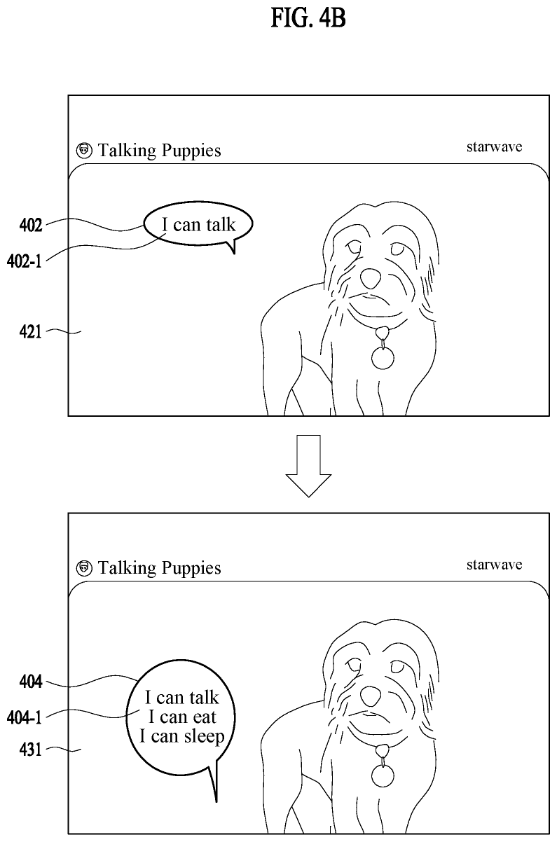

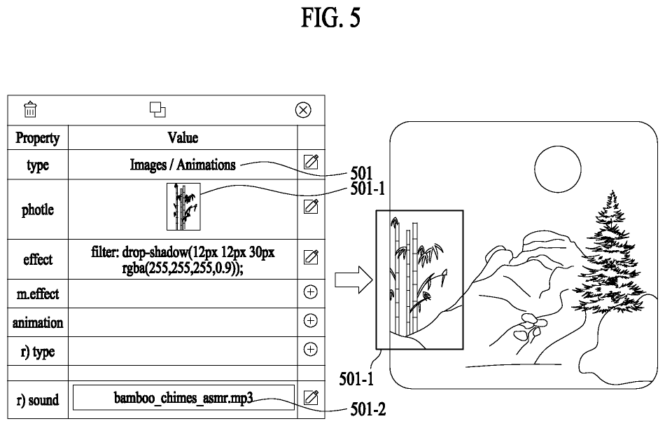

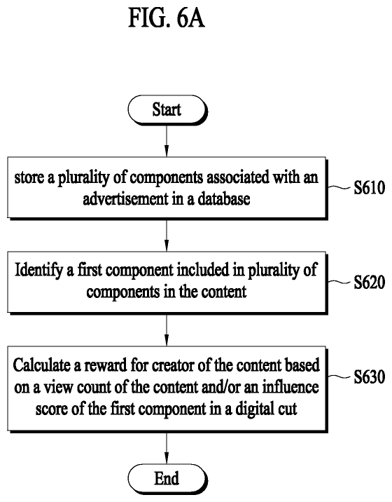

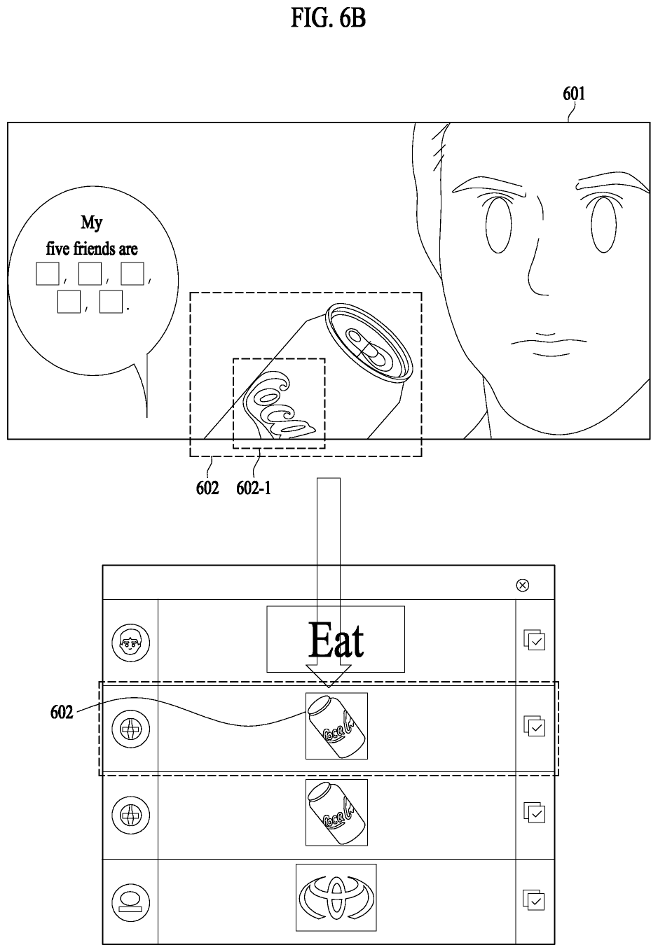

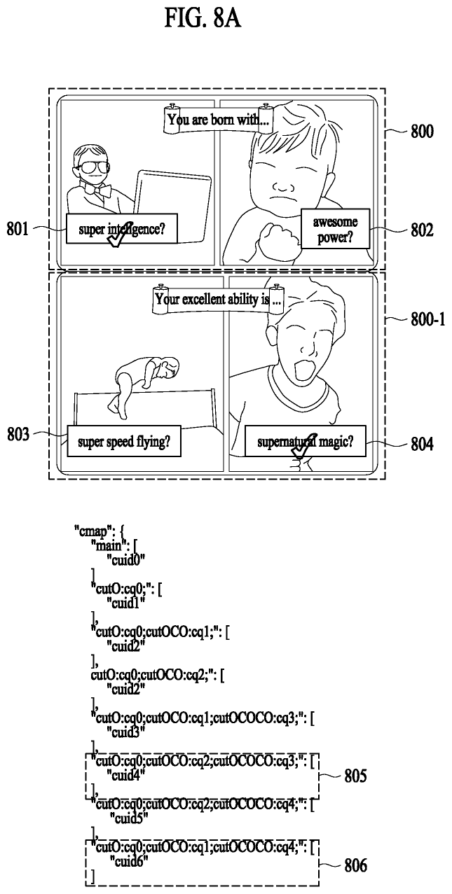

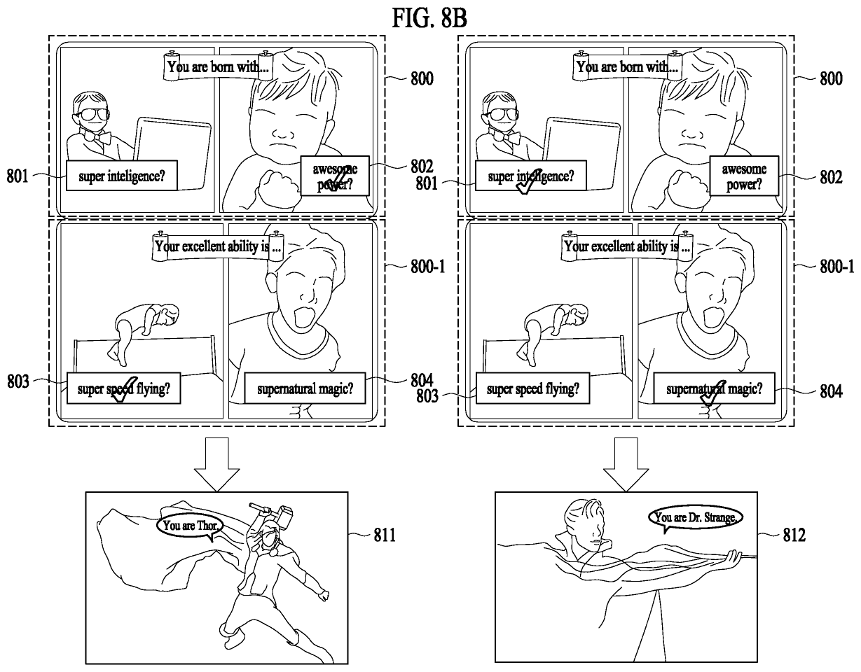

In this regard, the electronic device 100 provides a contents (e.g., content 310, content 320, content 330, and content 340) including according to an embodiment of the present disclosure. The content to be displayed on the user terminal 120 may be generated by using a script-based standard form (e.g., Javascript object notation (JSON)) for showing data structured with object notations. At this point, the content may be one sequence formed by gathering the plurality of digital cuts. A digital cut may be one unit (e.g., a digital cut 401 and a digital cut 411 of FIG. 4A, a digital cut 421 of FIG. 4B, a digital cut 601 of FIG. 6B, and digital cuts 801 through 804 of FIG. 8A) in a content formed by gathering the components. A component may be a text (e.g., a text 402-1 and a text 412-1 of FIG. 4A), a text box (e.g., a text box 402 and a text box 402 of FIG. 4A), an image (e.g., a component 602 and a component 602-1 of FIG. 6B and a component 501-1 of FIG. 5), a sound (e.g., a sound 501-2 of FIG. 5, or the like. Unlike the related conventional content providing method which uses the unalterable image having data loss on each component, the electronic device 100 may provide a content including overall components (e.g., a text, an image, a sound, and a video) to a screen of the user terminal 120. Also, the electronic device 100 may provide the content including the plurality of digital cuts in which the data on each component is intact and maintained. For example, a JSON file may be generated by receiving information associated with a digital cut displaying the content from the creator terminal 110 through the electronic device 110 according to an embodiment, and text information may be maintained in a web page or a web view (e.g., WebKitWeb View (WKWeb View)) published through the JSON file. Even after the web page is generated, a function such as a search, translation, text-to-speech (TTS) for the text may be implemented through the electronic device 100 according to an embodiment. In addition, information on the content including the text, the image, the sound, and the video may be used through the electronic device 100 according to an embodiment to be reused in other content. Furthermore, a content creator creating the content with the creator terminal 110 through the electronic device 100 may provide content in which predetermined components are to be selectively provided only to the user terminal 120 which satisfies a predetermined condition (e.g., a condition of a membership subscription to a platform for a user or a condition of payment by the user). Through this method, the content creator may describe details for consumption of the predetermined components to users that have not yet signed up for a platform associated with the electronic device 100 and induce more users to sign up for a membership of the platform at a same time. The content creator can also acquire a higher reward that is associated with a payment history of an amount which a content user pays due to the content of the creator.

The content creator creating the content with the creator terminal 110 through the electronic device 100 may freely change components in the content. Also, the content creator may use, for example, a product placement (PPL) function to advertise various products and may acquire a reward for providing an advertisement through the platform associated with the electronic device 100. Further details will be described below in FIGS. 6A and 6B.

A content user receiving the content by using the user terminal 120 through the electronic device 100 according to an embodiment may receive the content having further accurate objectivity unlike before. For example, the user may not only identify a popular content through an existing like/dislike function of reflecting user preference for details included in the provided content, but also acquire an opportunity to receive a content having high reliability through a function of reflecting accuracy with which the user determines details included in the content to be correct or incorrect. In an embodiment, an input on the accuracy for the details included in the content may have a limited number of times of utilization for each user in order to prevent malicious accuracy manipulation by some users.

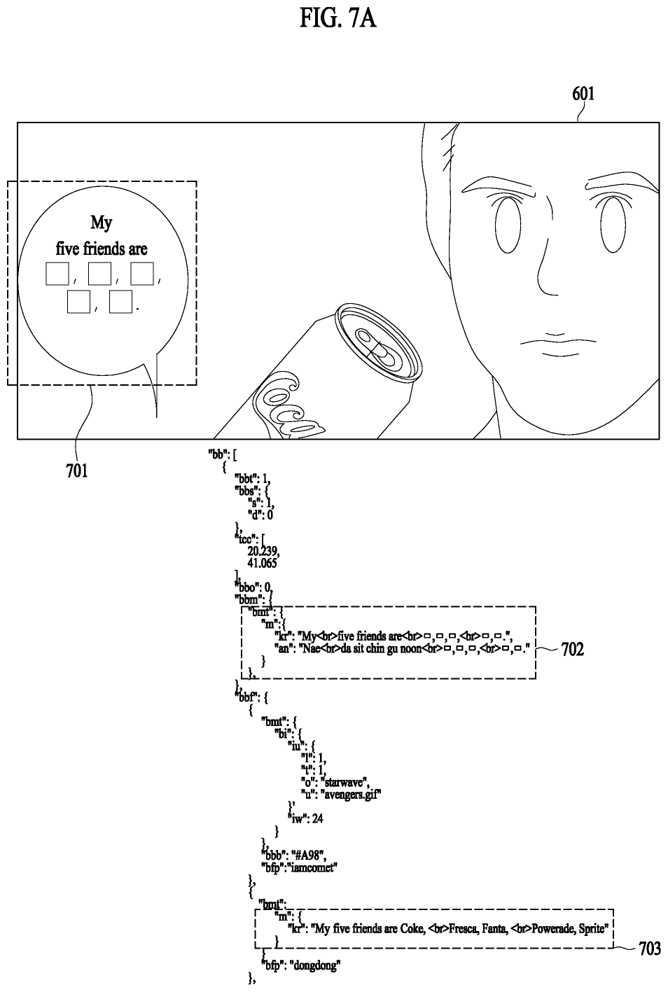

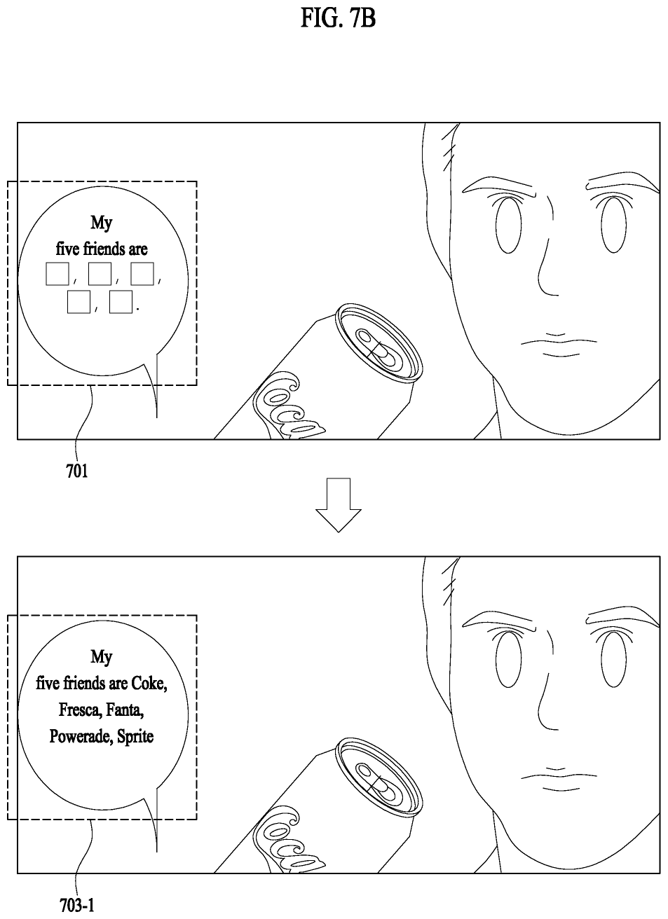

In addition, the content user may experience various events in one piece of the content through a bubble fill function and a “choose your own story” (CYOS) function. Details thereof will be described below in FIGS. 7A, 7B, 8A, and 8B.

FIGS. 4A and 4B are diagrams illustrating an example of a text included in a digital cut according to an embodiment.

Referring to FIG. 4A, the electronic device 100 according to an embodiment may identify first information of components included in each cut included in the plurality of digital cuts based on a creator input and generate a first file in a first format based on the first information. At this point, the first information may be information of at least one component selected from a text, a text box surrounding the text, an image, a sound, and a video (e.g., the text box 402, the text 402-1, the text box 412, and the text 412-1. The electronic device 100 may generate the file in the first format in consideration of a size of each cut included in the plurality of digital cuts, a ratio of a size of a component included in each cut to the size of each cut included in the digital cuts, and a position of the components included in each cut included in the digital cuts.

At this point, the electronic device 100 may identify the first information of at least one component selected from a text, a text box surrounding the text, an image, a sound, and a video. For example, components included in the digital cuts 401 and 411 may include the texts 402-1 and 412-1 and the text boxes 402 and 412 surrounding the texts 402-1 and 412-1. For example, a code portion 403 is included in a first file in a first format. The code portion 403 indicates that a center of the text box 402 including the text 402-1 may be positioned at a point having a distance of 27.337 percent of an entire horizontal length from a leftmost end point of a screen of the user terminal 120 and a distance of 20.588 percent of an entire vertical length from an uppermost end point of the screen. The electronic device 100 may generate the first file in the first format so that the text box 402 is provided to the user terminal 120 based on a position of the center of the text box 402. Similarly, a code portion 413 indicates that a center of the text box 412 including the text 412-1 may be positioned at a point having a distance of 77.8 percent of the entire horizontal length from the leftmost end point of the screen of the user terminal 120 and a distance of 20.1 percent of the entire vertical length from the uppermost end point of the screen. The electronic device 100 may generate the first file in the first format so that the text box 412 is provided to the user terminal 120 based on a position of the center of the text box 412.

Referring to FIG. 4b, the electronic device 100 according to an embodiment may change a size of the text in proportion to the size of the digital cut. For example, a size of the text 402-1 included in the digital cut 421 may be increased in proportion to a size of the digital cut 421 when the size of the digital cut 421 is increased. The size of the text 402-1 included in the digital cut 421 may be decreased in proportion to the size of the digital cut 421 when the size of the digital cut 421 is decreased. In an embodiment, a size of the text box may be changed in proportion to the length of the text. For example, a size of the text box 402 including the text 402-1 may be increased to be a size of a text box 404 when a length of the text 402-1 is increased to be that of a text 404-1 included in a digital cut 431. In contrast, the size of the text box 402 including the text 402-1 may be decreased by a decreased length of the text 402-1 when the length of the text 402-1 is decreased. In an embodiment, the texts 402-1 and 404-1 may be character-recognizable through a web page. Through this method, a TTS function or a translation function may be allowed.

FIG. 5 is a diagram illustrating an example of each component included in a plurality of digital cuts according to an embodiment.

Referring to FIG. 5, first information identified by the electronic device 100 according to an embodiment may include information on a predetermined action corresponding to an event associated with a first component among components included in each digital cut of the plurality of digital cuts. The electronic device 100 may provide a first action corresponding to the event associated with the first component through the user terminal 120 when receiving an input on occurrence of the event associated with the first component through the user terminal 120. The event at this point may include an event in which a predetermined component newly appears during the provision of content, an event in which the predetermined component is touched through the user terminal 120, an event in which a digital cut including the predetermined component is scrolled through the user terminal 120 to appear, and an event in which the digital cut including the predetermined component is scrolled through the user terminal 120 to disappear. In addition, an action corresponding to the above-described event may include overall actions or special effects to be visually or aurally sensed by a consumer of the content. However, it is merely an example, and embodiments according to the present disclosure are not limited thereto.

The electronic device 100 according to an embodiment may provide a predefined action by playing the sound 501-2 corresponding to an event associated with the component 501-1. For example, the sound 501-2 may be played when receiving an input on occurrence of an event associated with the component 501-1 (e.g., a touch input on the component 501-1 from a user) from the user terminal 120. Also, the electronic device 100 may determine a type 501 of the component 501-1 to be a motion animation type that is not a still image and may provide the predefined action by providing a shaking effect of the component 501-1 to correspond to the event associated with the component 501-1 after receiving the input on the occurrence of the associated event (e.g., an event in which the component 501-1 newly appears in the user terminal 120, an event in which the component 501-1 is touched, an event in which a digital cut including the component 501-1 is scrolled to appear, and an event in which the digital cut including the component 501-1 is scrolled to disappear). At this point, the component 501-1 included in each cut and a response to selection of the component 501-1 may be defined based on an open-source image or sound provided in a platform associated with the electronic device 100 which provides the content including the plurality of digital cuts. For example, the electronic device 100 may provide a touchable feature with which a user and the content may interact with each other. Through this method, the electronic device 100 may provide the content while all pieces of information of components included in the content are maintained, which is unlike a conventional content being all fixed and provided through the user terminal 120.

FIGS. 6A and 6B are diagrams illustrating an advertisement function using a content including a plurality of digital cuts according to an embodiment.

Referring to FIG. 6A, in operation S610, the electronic device 100 according to an embodiment may store a plurality of components associated with an advertisement in a database. For example, the electronic device 100 may receive the plurality of components (e.g., an advertisement image, a title of an advertised product, or the like) associated with the advertisement from an advertiser of a product to be advertised and may store the plurality of components in the database which is associated with a method of providing the content.

In operation S620, the electronic device 100 may identify a first component included in the plurality of components in the content. The electronic device 100 may identify the first component included in the content among the plurality of components associated with the advertisement and stored in the database. In operation S620, the electronic device 100 may provide an advertisement associated with the first component to the user terminal 120 when receiving an input on the first component from the user terminal 120.

In operation S630, the electronic device 100 may calculate a reward for a creator of the content based on one or more factors, including a view count of the content and/or an influence score of the first component in a digital cut. At this point, the influence score of the first component may be calculated based on one or more factors, including size information of the first component in the digital cut and/or position information of the first component in the digital cut.

Through operation S610 to operation S630, the content creator that creates the content may provide the advertisement to users by adding the plurality of components associated with the advertisement to the content through a platform associated with the electronic device 100 without an additional direct contract with the advertiser. Specific embodiments of the advertisement function using the content including the plurality of digital cuts will be described below in FIG. 6B.

Referring to FIG. 6B, embodiments of providing the advertisement function by using the electronic device 100 according to an embodiment are illustrated.

The advertiser that may advertise a predetermined product through the content in the electronic device 100 according to an embodiment may provide a component (e.g., an image, a video, or a sound) including identification information of an advertisement to the content creator through the platform associated with the electronic device 100. The content creator who creates the content including the plurality of digital cuts may create the content by using the component (e.g., the image, the video, or the sound) including the identification information of the advertisement in the platform associated with the electronic device 100 through the creator terminal 110.

For example, the electronic device 100 may provide the content including the first component (e.g., a component 602 and a component 602-1) included in the plurality of components associated with the advertisement and stored in the database. For example, the first component (e.g., the component 602 and the component 602-1) may be at least one of a text, an image, a video, and a sound received from the advertiser for the advertisement. For example, the electronic device 100 may receive an input on the selection of the first component (e.g., the component 602 and the component 602-1) included in the plurality of components associated with the advertisement from the user terminal 120. An operation of receiving the input on the selection of the first component included in the plurality of components associated with the advertisement may be similar to an operation of receiving an input on selection of the touchable feature with which the user and the content may interact with each other as described above by FIG. 5. At this point, a user may receive, through the selection of the first component included in the plurality of components associated with the advertisement, for example, a web page for introducing the product to be advertised. However, it is merely an example, and embodiments of the electronic device 100 providing the advertisement function according to the present disclosure are not limited thereto.

The electronic device 100 according to an embodiment may calculate a reward for the content creator of the content in consideration of one or more factors, including the view count of the content and/or the influence score of the first component in the digital cut as the content creator includes the identification information of the advertisement through the creator terminal 110 and provides the content through the user terminal 120. The electronic device 100 may calculate a predetermined ratio of an entire advertisement cost to be the reward for the content creator of the content in consideration of the view count of the content including the identification information of the advertisement and the influence score of the first component in the digital cut. For example, in some cases, the electronic device 100 may calculate the reward for the content creator based on a predetermined proportion set for each of the view count of the content and the influence score of the first component. The influence score of the first component, for example, may be calculated based on one or more factors, including the size information of the first component which is positioned in a digital cut and/or position information of the first component in the digital cut. For example, the influence score of the first component may be calculated to be higher when the size of the first component positioned in the digital cut is greater. For example, the influence score of the first component may be calculated to be higher when the first component is positioned closer to a center of the digital cut in which the first component is positioned. The electronic device 100 may calculate the reward for the content creator based on the influence score of the first component which is calculated as such. For example, the electronic device 100 may calculate the reward of the content creator to be greater when the content includes first components 602 and 602-1 which are included in the digital cut 601, and when the view count of the content which is viewed with the user terminal 120 is greater. In addition, for example, the electronic device 100 may calculate the reward for the content creator of the content to be greater when the content includes the first components 602 and 602-1 included in the digital cut 601, when a proportion of a size of the first components 602 and 602-1 in the digital cut 601 is greater, and when the first components 602 and 602-1 are positioned closer to a center of the digital cut.

As such, the creator may receive the reward for an effect of the advertisement through the electronic device 100 without the additional contract with the advertiser.

FIGS. 7A and 7B are diagrams illustrating an example of an interaction based on a user input in content including a plurality of digital cuts according to an embodiment.

Referring to FIG. 7A, the electronic device 100 may receive, through the user terminal 120, user input information associated with a first component included in components included in each cut of the plurality of digital cuts and provide the content to which the user input information is added through another user terminal. For example, in association with a component 701, a code portion 702 includes a code for outputting a text “my five friends” in a form of the first component and is included in a first file in a first format. When the electronic device 100 receives the user input information associated with the first component, such as those included in a code portion 703, the electronic device 100 may receive the content to which the user input information is added.

Referring to FIG. 7B, the electronic device 100 may receive, based on the received user input information, the content to which the user input information is added through the other user terminal. For example, the electronic device 100 may receive user input information associated with the component 701 and output content to which the user input information is added such as in component 703-1. Through such a bubble fill function, a user consuming the content may participate in content generation by directly inputting text information and share the content generation matters with another content consumer. In addition, for example, even when the electronic device 100 receives pieces of user input information from a plurality of user terminals through the plurality of user terminals, the electronic device 100 may separately collect the pieces of user information received from the plurality of user terminals as needed, arrange the pieces of user information in a chronological order, and provide content reflecting, in the chronological order, the pieces of user information received from the plurality of user terminals.

FIGS. 8A and 8B are diagrams illustrating an embodiment of providing different contents based on a content including a plurality of digital cuts according to an embodiment.

Referring to FIG. 8A, the electronic device 100 may identify second information on an order of exposure of a first digital cut and a second digital cut among the plurality of digital cuts based on a creator input. At this point, the second information may be information on in which order the plurality of digital cuts included in the content may be exposed in the content. The electronic device 100 may generate a first file in a first format based on first information associated with components included in the plurality of digital cuts and the second information on in which order the plurality of digital cuts included in the content may be exposed in the content. The electronic device 100 may provide, when the user terminal 120 receives an input for selecting the first digital cut from at least a portion of the digital cuts, the content which displays the first digital cut followed by the second digital cut to the user terminal 120. For example, such as in code portions 805 and 806, the electronic device 100 may identify the second information on the order of the exposure of the first digital cut and the second digital cut among the plurality of digital cuts and generate the first file in the first format based on the first information of the components included in each digital cut and the second information on the order of the exposure of the first digital cut and the second digital cut among the plurality of digital cuts. For example, when the user terminal 120 receives an input for selecting a first digital cut (e.g., the digital cut 801 or the digital cut 802) from at least a portion of the digital cuts 801 and 802 included in a digital cut 800, the electronic device 100 may arrange the content in an order that the first digital cut 801 is displayed first and then followed by a second digital cut 800-1.

Referring to FIG. 8B, specific embodiments of providing different contents based on the user input are illustrated. For example, the electronic device 100 may provide a content illustrated in FIG. 8B to the user terminal 120 after generating the first file in the first format based on the first information and the second information as described in FIG. 8A. At this point, the electronic device 100 may receive an input indicating a selection of the digital cut 802 from the digital cuts 801 and 802 included in the cut 800 from the user terminal 120 and receive an input indicating a selection of the digital cut 803 from the digital cut 803 and the digital cut 804 which are included in the digital cut 800-1. At this point, the electronic device 100 may provide the content 811 in a web page through a second file in a second format based on a user input. Similarly, the electronic device 100 may receive an input indicating a selection of the digital cut 801 from the digital cuts 801 and 802 included in the digital cut 800 from the user terminal 120 and receive an input indicting a selection of the digital cut 804 from the digital cuts 803 and 804 included in the digital cut 800-1. At this point, the electronic device 100 may provide the content 812 in the web page through the second file in the second format based on a user input. For example, the content 811 to be provided when the digital cut 802 and the digital cut 803 are selected in the user terminal 120 and the content 812 to be provided when the digital cut 801 and the cut 804 are selected in the user terminal 120 may be different from each other. The electronic device 100 providing the content including the plurality of digital cuts may provide a variety of contents depending on user inputs different from each other on various digital cuts included in the content.

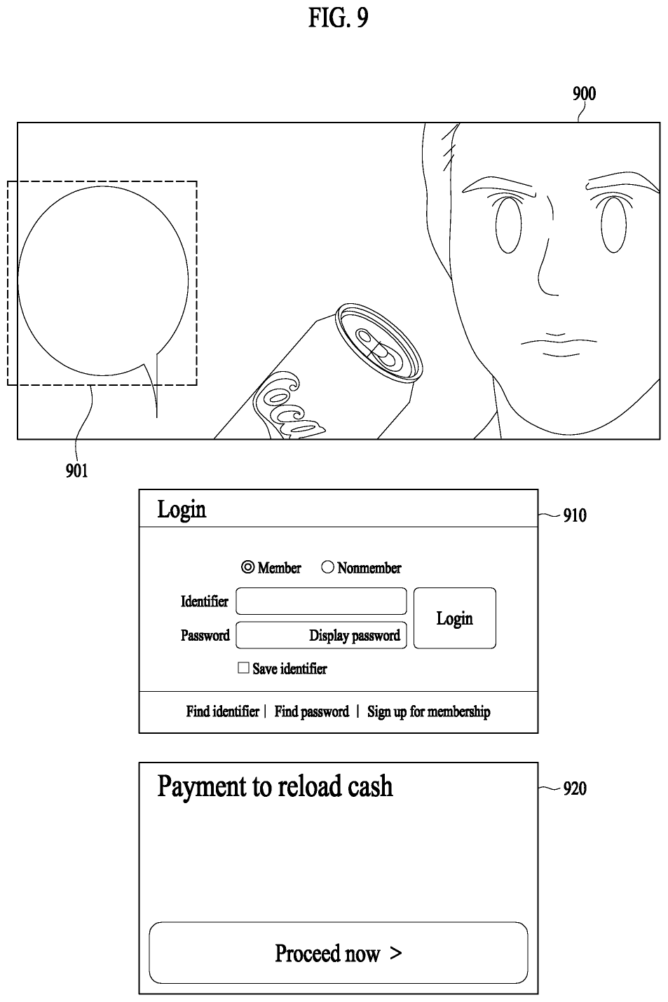

FIG. 9 is a diagram illustrating an embodiment of providing a content to a user terminal depending on whether a predetermined condition is satisfied according to an embodiment.

Referring to FIG. 9, for providing a predetermined digital cut or a predetermined component included in the content, the electronic device 100 may determine whether the user terminal 120 satisfies a predetermined condition and provide a content according to a determining result. For example. The electronic device 100 may exclude at least one digital cut (e.g., a digital cut 900) or at least one component (e.g., a component 901) from being provided to the user terminal 120 when the user terminal 120 does not satisfy the predetermined condition. At this point, the predetermined condition may include at least one condition selected from a plurality of conditions, including a condition of a membership subscription to a platform associated with the content and/or a condition of payment associated with the content. For example, the electronic device 100 may provide a content excluding the digital cut 900 or the component 901 to the user terminal 120 when the user terminal 120 does not satisfy a condition of a membership subscription to a platform associated with the content (for example, when the user terminal 120 does not log into the platform). Similarly, the electronic device 100 may provide the content excluding the digital cut 900 or the component 901 to the user terminal 120 when the user terminal 120 does not satisfy a condition of payment associated with the content (for example, when the payment is not performed although all the content to watch is to be provided upon the payment). In addition, when the user terminal 120 does not satisfy the predetermined condition, the electronic device 100 may provide details for at least one of the condition of a membership subscription to the platform associated with the content and the condition of the payment associated with the content to the user terminal. For example, when the user terminal 120 does not satisfy the condition of a membership subscription to the platform associated with the content, the electronic device 100 may provide details for the condition of a membership subscription to the platform through a page 910. Through this, the electronic device 100 may allow the user terminal to identify an identifier and a password to log into the platform. For example, when the user terminal 120 does not satisfy the condition of the payment associated with the content, the electronic device 100 may induce the user terminal 120 to perform the payment associated with the content by providing details for the condition of the payment associated with the content through a page 920. However, it is merely an example, and the specific embodiments of the predetermined condition and the other particulars described above are not limited thereto.

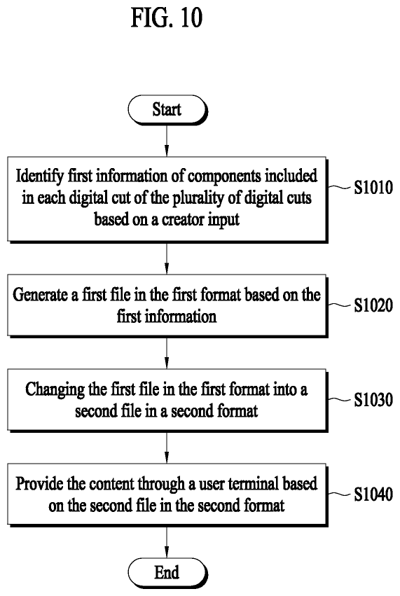

FIG. 10 is a flowchart illustrating a method of providing content including a plurality of digital cuts according to an embodiment.

Referring to FIG. 10, in operation S1010, the electronic device 100 according to an embodiment may identify first information of components included in each cut included in the plurality of digital cuts based on a creator input. At this point, the electronic device 100 may identify the first information of at least one component selected from a text, a text box surrounding the text, an image, a sound, and a video.

In operation S1020, the electronic device 100 may generate the first file in a first format based on the first information. At this point, the electronic device 100 may generate the first file in the first format in consideration of a size of each digital cut included in the plurality of digital cuts, a ratio of a size of a component included in each digital cut to the size of each digital cut, and a position of the components included in each cut.

In operation S1030, the electronic device 100 may change the first file in the first format into a second file in a second format. At this point, the first file in the first format may be a Javascript object notation (JSON) file, and the second file in the second format may be a hypertext markup language (HTML) file.

In operation S1040, the electronic device 100 may provide the content to the user terminal 120 based on the second file in the second format. At this point, the electronic device 100 may provide the content in a web page based on the second file in the second format, and the first information may be searchable through the web page.

After the content is generated and provided to the user terminal 120 through operation S1010 to operation S1040, the electronic device 100 may receive information on an accuracy of the content from a plurality of user terminals 120. The electronic device 100 may calculate an accuracy score of the content based on the received information and provide information about the accuracy score of the content to the user terminal 120. Also, the electronic device 100 may provide a list of a plurality of pieces of contents arranged based on the accuracy score of each content piece. At this point, a user input on the information about the accuracy of the content may have restrictions to prevent a malicious manipulation of the accuracy. For example, a number of times that the user can provide input on the accuracy may be limited to a range predefined for each of the user terminals 120. For example, the electronic device 100 may receive, from a user consuming the content, a feedback about whether the content is correct or incorrect. The feedback also has a limited number of times of utilization. The electronic device 100 may provide, to the user terminal 120, a content evaluated to be highly accurate by multiple users based on information about an accuracy score of the content calculated based on information about accuracy.

The electronic device 100 may store information on a plurality of components in a database based on at least one creator input. At this point, the electronic device 100 may identify the components included in each digital cut included in the plurality of digital cuts among the plurality of components based on the creator input. At this point, identification information of a first component included in the plurality of components may include identification information of a first creator generating the first component. Through this, the electronic device 100 may store, in a database, predetermined components used by a predetermined creator for creating content. Thereafter, the electronic device 100 may allow another creator to use the stored predetermined components to create new contents. In addition, the electronic device 100 may calculate a reward for the first creator. For example, the reward may be calculated in consideration of a number of times of using the first component in a plurality of pieces of contents. In other words, even when components used for creating content are stored in a database and reused after the content is generated by a predetermined creator, the electronic device 100 may calculate a reward for an original creator who generates the components in the earliest time. Through this method, multiple creators may improve productivity in a collaborative content creation project.

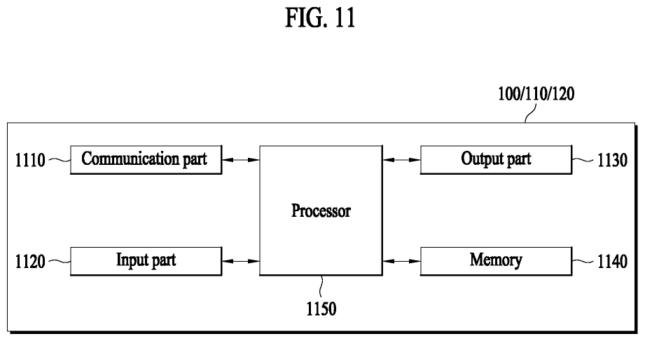

FIG. 11 is a block diagram illustrating an electronic apparatus, a creator terminal, and a user terminal according to an embodiment.

Referring to FIG. 11, each of the electronic device 100, the creator terminal 110, and the user terminal 120 may include a communication part 1110, an input part 1120, an output part 1130, a memory 1140, and a processor 1150. However, all elements illustrated in FIG. 11 may not be essential elements of the electronic device 100, the creator 110, and the user terminal 120. The electronic device 100, the creator terminal 100, and the user terminal 120 may be implemented by other elements in addition to the elements illustrated in FIG. 11 or some of the elements illustrated in FIG. 11.

The communication part 1110 may transmit and receive data to and from external devices by using wired or wireless communication technology. For example, an operation performed by the communication part 1110 may be identical to the operation performed by the communication part 210 in FIG. 2.

The input part 1120 may acquire a variety of data. At this point, the input part 1120 may include a camera for an image signal input, a microphone for receiving an audio signal, or the like. The input part 1120 may be a device with which a content creator inputs data for controlling the creator terminal 110 and may be a device with which a user inputs data for controlling the user terminal 120. For example, examples of the input part 1120 may include a key pad, a dome switch, a touch pad (of a contact capacitance type, a pressure resistive type, an infrared ray detection type, a surface ultrasonic wave conduction type, an integral tension measurement type, a piezo effect type, or the like), a jog wheel, a jog switch, or the like. However, it is merely an example.

The output part 1130 may generate an output associated with visual sensation, auditory sensation, tactual sensation, or the like. The output part 1130 may include a display that outputs visual information, a speaker that outputs auditory information, a haptic module that outputs tactual information, or the like.

The memory 1140 may store data for supporting various functions of the electronic device 100, the creator terminal 110, and the user terminal 120. For example, the memory 1140 may store the variety of data or the like in the input part 1120. For example, the memory 1140 may perform a function similar to that of the storage of the controller in FIG. 2. That is, the memory 1140 may be hardware that stores a variety of data processed in the electronic device 100, the creator terminal 110, and the user terminal 120. The memory 1140 may store data to be processed or data that has been processed in the electronic device 100, the creator terminal 110, and the user terminal 120. In addition, the memory 1140 may store applications or drivers to be operated by the electronic device 100, the creator terminal 110. The memory 1140 may include a random access memory (RAM) such as a dynamic random access memory (DRAM) and a static random access memory (SRAM), a read-only memory (ROM), an electrically erasable programmable read-only memory (EEPROM), a compact disc (CD)-ROM, an optical disc storage including Blu-ray, a hard disk drive (HDD), a solid state drive (SSD), or a flash memory.

The processor 1150 may determine at least one function performable by the electronic device 100, the creator terminal 100, and the user terminal 120. Also, the processor 1150 may perform the determined function by controlling elements of the electronic device 110, the creator terminal 110, and the user terminal 120. For example, the processor 1150 may perform operations similar to those of the controller 220 in FIG. 2. In other words, the processor 1150 may perform a role of controlling respective overall operations of the electronic device 100, the creator terminal 110, and the user terminal 120. For example, the processor 1150 may generally control each of the electronic device 100, the creator terminal 110, and the user terminal 120 by executing programs stored in the memory 1140 of each of the electronic device 100, the creator terminal 110, and the user terminal 120. The processor 1150 may be implemented with a central processing unit (CPU), a graphics processing unit (GPU), an application processor (AP), or the like provided in each of the electronic device 100, the creator terminal 110, and the user terminal 120, but it is merely an example. Methods implemented with a software module or an algorithm according to the above-described embodiments may be stored in a computer-readable recording medium, as computer-readable codes or program instructions that may be executed in the processor 1150 or the controller 220. At this point, examples of the computer-readable recording medium include a magnetic storage medium (e.g., a ROM, a RAM, a floppy disk, a hard disk, or the like), an optical reading medium (e.g., a CD-ROM and a digital versatile disk (DVD)), or the like. The computer-readable recording medium may be distributed among computer systems connected to each other through a network so that a computer-readable code may be stored and executed in a distributed manner. The medium may be readable by a computer, stored in a storage, and executed in the processor 1150 or the controller 220.

The present specification and drawings have been described with respect to the embodiments of the present disclosure. Although specific terms are used, it is only used in a general sense to easily explain the technical content of the present disclosure and to help the understanding of the invention, and is not intended to limit the scope of the specification. It will be apparent to those skilled in the art that other modifications based on the technical spirit of the present disclosure may be implemented in addition to the embodiments disclosed herein.

The present embodiments may be represented by functional blocks and various processing steps. These functional blocks may be implemented by various numbers of hardware and/or software configurations that execute specific functions. For example, the present embodiments may adopt integrated circuit configurations such as a storage, a processor, a logic circuit, and a look-up table that may execute various functions by control of one or more microcontrollers or other control devices. Similarly to that elements may be executed by software programming or software elements, the present embodiments may be implemented by programming or scripting languages such as C, C++, Java, assembler, Javascript and Python including various algorithms implemented by combinations of data structures, processes, routines, or of other programming configurations. Functional aspects may be implemented by algorithms executed by one or more processors. In addition, the present embodiments may adopt the related art for electronic environment setting, signal processing, and/or data processing, for example. The terms “mechanism”, “element”, “means”, and “configuration” may be widely used and are not limited to mechanical and physical components. These terms may include the meaning of a series of routines of software in association with a processor, for example.

The above-described embodiments are merely examples and other embodiments may be implemented within the scope of the following claims.

1. A method of providing a content including a plurality of digital cuts, the method comprising:
identifying, via an electronic device, first information of components included in each digital cut of the plurality of digital cuts based on a creator input, wherein the electronic device is coupled to a plurality of user terminals via a network;
generating, via the electronic device, a first file in a first format based on the first information;
changing, via the electronic device, the first file in the first format into a second file in a second format; and
providing the content from the electronic device to a first user terminal of the plurality of user terminals via the network based on the second file in the second format;
storing a plurality of components associated with an advertisement in a database;
identifying a first component included in the plurality of components in the content; and
determining a reward for a creator of the content based on an influence score of the first component, wherein the influence score is determined based on at least one selected from the group consisting of size information of the first component and position information of the first component,
wherein at least one of the reward is proportional to at least one of a size of the first component relative to the content or a location of the first component relative to a fixed point of the content.

2. The method of claim 1, wherein providing the content comprises providing the content in a web page based on the second file in the second format, and
the first information is searchable through the web page.

3. The method of claim 1, wherein generating the first file in the first format comprises generating the first file in the first format in consideration of a size of each digital cut of the plurality of digital cuts, a ratio of a size of a component included in each digital cut to the size of each digital cut, and a position of a component included in each digital cut.

4. The method of claim 1, wherein identifying the first information comprises identifying the first information of at least one component selected from a text, a text box surrounding the text, an image, a sound, and a video.

5. The method of claim 4, wherein a size of the text is changed in proportion to a size of a digital cut.

6. The method of claim 4, wherein a size of the text box is changed in proportion to a length of the text.

7. The method of claim 4, wherein the text is character-recognizable.

8. The method of claim 1, wherein the first information includes information of a predetermined first action corresponding to a first event, the first event being associated with a first component among the components included in each digital cut of the plurality of the digital cuts, and the method further comprises providing the first action through the first user terminal when the first event occurs.

9. (canceled)

10. (canceled)

11. The method of claim 1, further comprising:
receiving, through the first user terminal, user input content information associated with the first component included in the components included in each digital cut; and
providing the content that includes the user input content information added through to another user terminal of the plurality of user terminals via the network, wherein the user input information is added to the content.

12. The method of claim 1, further comprising:
receiving information about an accuracy of the content from the plurality of user terminals;
calculating an accuracy score of the content based on the received information; and
providing information about the accuracy score of the content to the first user terminal,
wherein a number of times that a user is allowed to input on the information about the accuracy of the content is limited to a range predefined for each of the plurality of user terminals.

13. The method of claim 12, further comprising providing a list of a plurality of pieces of contents arranged based on an accuracy score of each content piece to the first user terminal.

14. The method of claim 1, further comprising:
identifying second information about an order of exposure of a first digital cut and a second digital cut among the plurality of digital cuts based on the creator input,
generating the first file in the first format based on the first information and the second information, and
providing, when the first user terminal receives an input for selecting the first digital cut from at least a portion of the digital cuts, the content in which the first cut is displayed first and then followed by the second cut to the first user terminal.

15. The method of claim 1, further comprising:
storing information of a plurality of components in a database based on at least one creator input; and
identifying at least one of the components included in each digital cut among the plurality of components and identification information of a creator based on the creator input.

16. The method of claim 15, wherein identification information of a first component included in the plurality of components includes identification information of a first creator generating the first component, and
the method further comprises calculating a reward for the first creator in consideration of a number of times of using the first component in a plurality of pieces of contents.

17. The method of claim 1, further comprising:
determining whether the first user terminal satisfies a predetermined condition; and
providing the content which excludes at least one digital cut or at least one component to the user terminal when first the user terminal does not satisfy the predetermined condition,
wherein the predetermined condition includes at least one of a condition of a membership subscription to a platform associated with the content and a condition of payment associated with the content.

18. The method of claim 17, further comprising:
when the first user terminal does not satisfy the predetermined condition, providing details for at least one of the condition of the membership subscription to the platform associated with the content and the condition of the payment associated with the content to the first user terminal.

19. The method of claim 1, wherein the first file in the first format is a Javascript object notation (JSON) file, and
the second file in the second format is a hypertext markup language (HTML) file.

20. An electronic device for performing a method of providing a content including a plurality of digital cuts, the electronic device comprising:
a communication part configured to communicate with a plurality of user terminals; and
a controller configured to:
identify, via an electronic device, first information of components included in each digital cut of the plurality of digital cuts based on a creator input, wherein the electronic device is coupled to a plurality of user terminal vias a network;
generate, via an electronic device, a first file in a first format based on the first information;
change, via an electronic device, the first file in the first format into a second file in a second format;
provide the content from the electronic device to a first user terminal of the plurality of user terminals via the network based on the second file in the second format;
store a plurality of components with an advertisement in a database;
identify a first component included in the plurality of components in the content; and
determine a reward for a creator of the content based on an influence score of the first component, wherein the influence score is determined based on at least one selected from the group consisting of size information of the first component and position information of the first component, and wherein at least one of the reward is proportional to at least one of a size of the first component relative to the content or a location of the first component relative to a fixed point of the content.
